(19) United States
(12) Patent Application Publication
(10) Pub. No.: US 2016/0196657 A1
(43) Pub. Date: Jul. 7, 2016

(54) METHOD AND SYSTEM FOR PROVIDING DEPTH MAPPING USING PATTERNED LIGHT

(71) Applicant: Oculus VR, LLC, Menlo Park, CA (US)

(72) Inventors: Niv Kantor, Petah Tiqwa (IL); Nadav Grossinger, Karmei Yosef (IL); Nitay Romano, Geva Binyamin (IL)

(21) Appl. No.: 14/988,411

(22) Filed: Jan. 5, 2016

Related U.S. Application Data
(60) Provisional application No. 62/100,340, filed on Jan. 6, 2015.

(51) Int. Cl. G06T 7/00; G06K 9/62; G06K 9/34; G06K 9/46

(52) U.S. Cl. CPC G06T 7/0057; G06T 7/0085; G06K 9/4604; G06K 9/6202; G06K 9/34; G06T 2207/10028; G06T 2207/30196

(57) ABSTRACT

A method and system for estimating edge data in patterned light analysis are provided herein. The method may include: obtaining an original depth map of an object generated based on structured light analysis of a pattern comprising stripes; determining portions of the original depth map in which z-axis value is inaccurate given an edge of the object; detecting geometric feature of the object associated with the determined portion, based on neighboring portions of the depth map; and estimating the missing z-axis data along the edge of the object, based on the detecting geometric feature of the object.

### TECHNICAL FIELD

The present invention relates generally to structured light and more particularly, to improving the depth map data achieved via structured light projection.

### BACKGROUND OF THE INVENTION

Prior to the background of the invention being set forth, it may be helpful to set forth definitions of certain terms that will be used hereinafter.

The term ‘structured light’ as used herein is defined as the process of projecting a known pattern of pixels on to a scene. The way that these deform when striking surfaces allows vision systems to calculate the depth and surface information of the objects in the scene. Invisible structured light uses structured light without interfering with other computer vision tasks for which the projected pattern will be confusing.

The term ‘depth map’ as used herein is defined as an image that contains information relating to the distance of the surfaces of scene objects from a viewpoint. A depth map may be in the form of a mesh connecting all dots with z-axis data.

The term ‘image segmentation’ or ‘segmentation’ as used herein is defined as the process of partitioning a digital image into multiple segments (sets of pixels). The goal of segmentation is to simplify and/or change the representation of an image into something that is more meaningful and easier to analyze. Image segmentation is typically used to locate objects and boundaries (lines, curves, etc.) in images, also referred to as ‘edges’.

One of challenges in generating a depth map of an object, via structured light analysis, is to derive a complete Z-axis data along the edge of the object, as determined in connection with the segmentation process of the object. In structured light analysis that is based on stripes or lines pattern this challenge is intensified due to the gaps between the stripes, and specifically for those cases in which object edge aligns with some of these gaps.

### SUMMARY OF THE INVENTION

According to some embodiments of the present invention, a method of estimating missing z-axis data along edges of depth maps derived via structured light analysis is provided herein. The method is based on using data associated with the geometrical features of the objects and sub objects, in order to estimate the missing z-axis data. For example, when the object is a hand (object), and the missing data is the z-axis data of points along the edge of the fingertip, the fact that the fingers (sub objects) are of cylindrical nature can be beneficial. In some embodiments, once a geometrical feature is recognized as such, a corresponding template is used to reconstruct the missing z-axis data.

In some embodiments, a depth map is obtained and segmented based on the original patterned light (the exact order is not important). Once the edge of the object is detected, usually based on 2D image and reduction of the intensity of the patterned light, an analysis of the portion of the depth map near the edge is being carried out. This analysis results with determining the geometric features of portion of the object that corresponds with the vicinity of the edge. The determined geometric feature is mapped to one of many predetermined templates which pose constraints on a curve fitting function that receives the existing z-axis values of the neighboring points in order to estimate the z-axis values of the desired points located along the edges.

In some embodiments, the additional z-axis values along the edge are used to complement the mesh of the depth map.

These, additional, and/or other aspects and/or advantages of the embodiments of the present invention are set forth in the detailed description which follows; possibly inferable from the detailed description; and/or learnable by practice of the embodiments of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

In the accompanying drawings:

FIG. 1 is a diagram illustrating a an object being illuminated by horizontal stripes light pattern according to embodiments of the present invention;

FIG. 2 is a mesh diagram illustrating several aspects in accordance with embodiments of the present invention;

FIG. 3 is a cross section diagram illustrating an aspect according to some embodiments of the present invention;

FIG. 4 is a block diagram illustrating a system according to some embodiments of the present invention;

FIG. 5 is a cross section diagram illustrating an aspect according to some embodiments of the present invention;

FIG. 6 is a block diagram illustrating several aspects of a system in accordance with embodiments of the present invention; and

FIG. 7 is a mesh diagram illustrating an aspect in accordance with embodiments of the present invention;

FIG. 8 is a graph diagram illustrating an aspect in accordance with embodiments of the present invention;

FIG. 9 is a graph diagram illustrating another aspect in accordance with embodiments of the present invention;

FIG. 10 is a high level flowchart that illustrates the steps of a non-limiting exemplary method in accordance with embodiments of the present invention; and

FIGS. 11A-11C are exemplary color depth maps illustrating aspects in accordance with embodiments of the present invention.

### DETAILED DESCRIPTION OF THE INVENTION

With specific reference now to the drawings in detail, it is stressed that the particulars shown are by way of example and for purposes of illustrative discussion of the preferred embodiments of the present technique only, and are presented in the cause of providing what is believed to be the most useful and readily understood description of the principles and conceptual aspects of the present technique. In this regard, no attempt is made to show structural details of the present technique in more detail than is necessary for a fundamental understanding of the present technique, the description taken with the drawings making apparent to those skilled in the art how the several forms of the invention may be embodied in practice.

Before at least one embodiment of the present technique is explained in detail, it should be understood that the invention is not limited in its application to the details of construction and the arrangement of the components set forth in the following description or illustrated in the drawings. The present technique is applicable to other embodiments or of being practiced or carried out in various ways. Also, it is to be understood that the phraseology and terminology employed herein is for the purpose of description and should not be regarded as limiting.

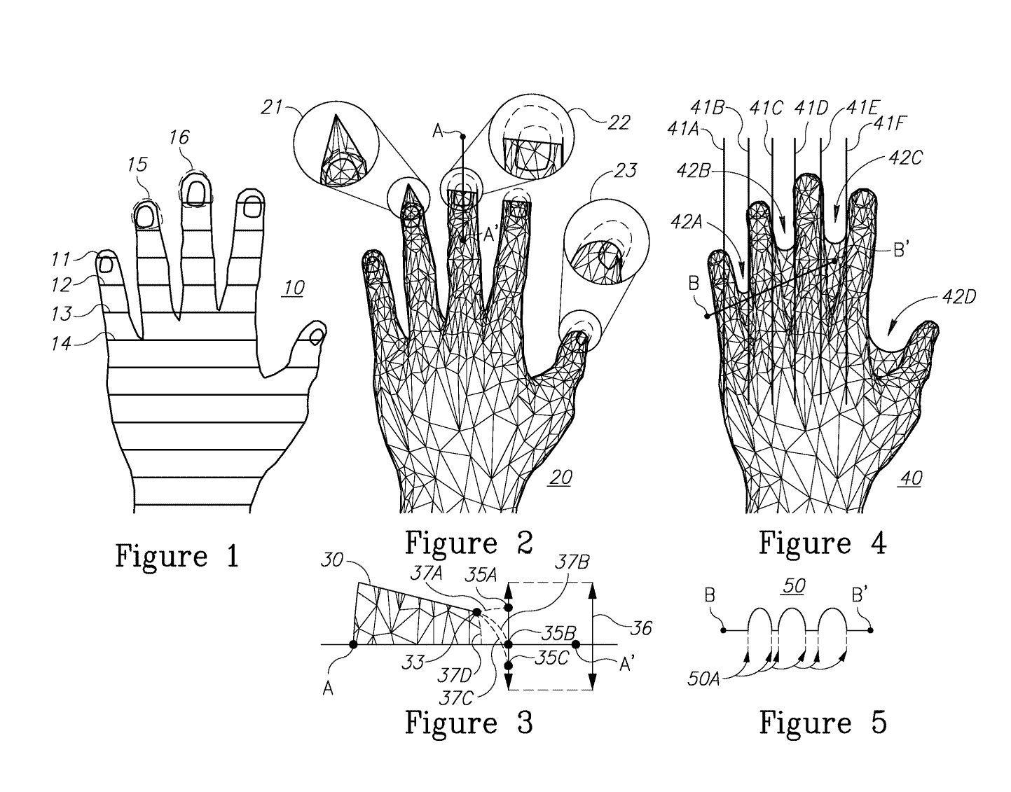

FIG. 1 is a diagram illustrating an object being illuminated by horizontal stripes (or lines) light pattern according to embodiments of the present invention. Hand 10 is covered with stripes such as 11, 12, 13, and 14 whose reflections are measured and analyzed to yield a depth map. As can be seen, due to the gap between stripes, some of the finger tips such as 15 and 16 are not covered by light pattern, at least not anywhere near the edge of the finger tip.

According to an exemplary embodiment, a sensor (not shown here) may be positioned in a certain Y-axis distance, for example near a transmitter which projects the stripes pattern on the hand and on the background (say a surface of a table the hand rests on, a wall, etc.). The position of the sensor is selected, so as to create a triangulation effect between the camera, the light projector and the light reflected back from the user's hand and the background.

The triangulation effect causes discontinuities in the pattern at the points along a stripe where there are significant depth shifts from an object projected with a light pattern. The discontinuities segment (i.e., divide) the stripe into two or more stripe segments, say a segment positioned on the hand, a segment position to the left of the hand and a segment position to the right of the hand.

Such depth shift generated stripe segments may be located on the contours of the user's hand's palm or digits, which are positioned between the camera and the user's body. That is to say that the user's digit or palm segments the stripe into two or more stripe segments. Once such a stripe segment is detected, it is easy to follow the stripe segment, to the stripe segment's ends.

The device may thus analyze bi-dimensional video data, to generate clusters of stripe segments. For example, the device may identify in the light pattern, a cluster of one or more stripe segments created by segmentation of stripes by a digit of the hand, say a cluster of four segments reflected from the hand's central finger. Consequently, the device tracks the movement of the digit, by tracking the cluster of stripe segments created by segmentation of stripes by the digit, or by tracking at least one of the cluster's segments.

The cluster of stripe segments created by segmentation (i.e., division) of stripes by the digit includes strip segments with an overlap in the X axis. Optionally, the stripe segments in the cluster further have similar lengths (derived from the fingers thickness) or relative proximity in the Y-axis coordinates.

On the X-axis, the segments may have a full overlap for a digit positioned straightly, or a partial overlap for a digit positioned diagonally in the X-Y plane. Optionally, the device further identifies a depth movement of the digit, say by detecting a change in the number of segments in the tracked cluster. For example, if the user stretches the user's central digit, the angle between the digit and the plane of the light projector and camera (X-Y plane) changes. Consequently, the number of segments in the cluster is reduced from four to three.

Optionally, the device further identifies in the light pattern, one or more clusters of one or more stripe segments created by segmentation of stripes by a palm of the hand.

The cluster of stripe segments created by segmentation of stripes by the palm includes an upper strip segment which overlaps with the user hand's fingers stripe segment clusters, in the X axis. The upper strip segment overlaps the four finger clusters in the X-axis, but does not exceed beyond the minimum and maximum X value of the four finger clusters' bottom segments.

The cluster of stripe segments created by segmentation of stripes by the palm further includes, just below segment, a few strip segments in significant overlap with the strip segment. The cluster of stripe segments created by segmentation of stripes by the palm further includes longer stripe segments that extend to the base of a stripe segment cluster of the user's thumb. It is understood that the digit and palm cluster's orientation may differ with specific hands positions and rotation.

FIG. 2 illustrates a depth map in the form of a mesh 20 derived by structured light analysis of the hand shown in FIG. 1. As can be seen, due to the lack of a light pattern near the edge of the fingertip of some fingers such as the thumb and the middle finger, z-axis data is inaccurate or incomplete in theses portions. Consequently, a mesh generated by dots having incorrect z-axis data will not represent well the corresponding portions of the object. For example, one undesirable effect shown in enlarged inset 21 is a cone-like fingertip caused by insufficient data as to the edge of the object. Another undesirable effect shown in enlarged inset 22 is a ‘cut-out’ fingertip caused by missing z-axis data near the fingertip edge. Yet another undesirable effect shown in enlarged inset 23 is a deformed fingertip (usually this occurs with the thumb) where inaccurate z-axis data is derived and the mesh is based thereon.

FIG. 3 illustrates a cross section of the depth data along the middle finger of the mesh shown in FIG. 2 and specifically along section A-A′. As shown, depth data 30 is derived for the portion covered with light pattern. However, beyond point 33 towards A′ no data can be directly derived since there is no light pattern around it. Range 36 illustrates the degree of freedom by which the z value of edge points 35A-35C, can be associated with. Several examples are 35A-35C each having a respective estimated mesh 37A-37D associated with, some are clearly inaccurate.

FIG. 4 is a diagram illustrating depth which may derive from structure light analysis where the pattern is vertical stripes according to the present invention. Here, a different undesirable effect is illustrated. The hand is covered here by vertical lines serving as patterned light. Due to the fact that the neighboring lines such as lines 41A, 41B and others are not aligned with the boundaries of the corresponding neighboring fingers, depth analysis of the data might ignore the gap between the fingers at least in its part as shown in 42A, and the edges between the fingers may mistakenly connected to one another forming a ‘duck’ shaped hand. This undesirable effect which may look like excessive skin 42A, 42B 42C between the fingers is illustrated in a cross section of B to B′ in FIG. 5 where all three fingers shown in cross section 50 to have a common plane with same z-axis value where the real finger lines 50A are actually separated.

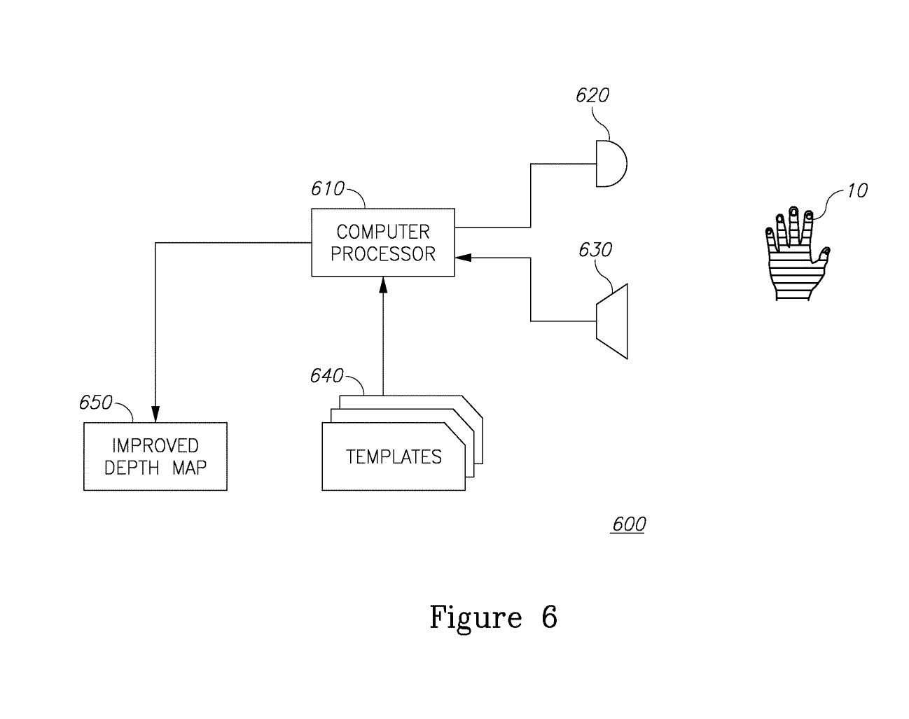

FIG. 6 is a block diagram illustrating several aspects of a system in accordance with embodiments of the present invention. System 600 may include a pattern illuminator 620 configured to illuminate object 10 with for example a line pattern. Capturing device 630 is configured to receive reflections which are analyzed by computer processor 610 to generate a depth map.

The generated depth map exhibit inaccurate or incomplete z-axis data along some of its off-pattern edges and other off-pattern portions. In order to solve that, computer processor 210 is configured to determine depth map portions in which z-axis value is missing or incorrect due to proximity to the edge of the object. The computer processor then goes on to detect geometric feature of the object associated with the determined depth map portions, based on neighboring portions being portions of the mesh that are proximal to the portions having points with missing or incorrect z-data of the depth map. The geometric feature is related to the structure of the surface of the object.

In some embodiments, computer processor 610 is configured to select a template function 640 based on the detected geometric feature and apply constraints to the selected template based on local geometrical features of the corresponding depth map portion. This yield a fitting function that is adjusted based on the type of geometric feature (e.g. cylindrical shape of a finger) and further based on the specific data derived locally from the portions of the depth map that have valid z-axis data.

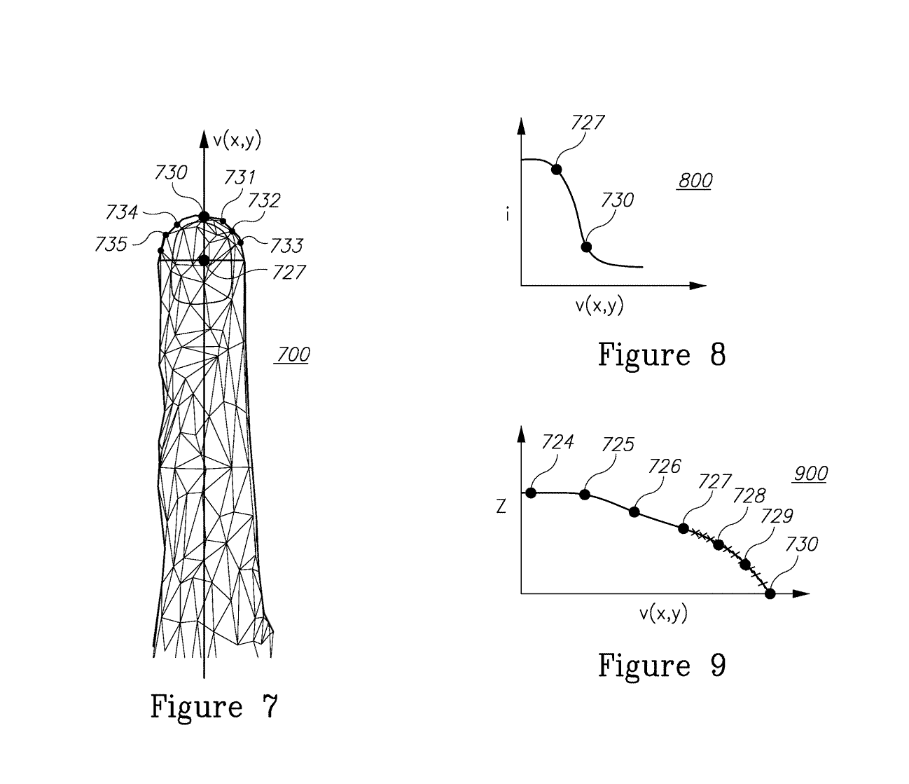

FIG. 7 is a mesh diagram 700 illustrating an aspect in accordance with embodiments of the present invention. Moving along the vector v(x,y), the edge points 730-735 may be detected as light intensity reduced below a predefined threshold as shown in FIG. 8 illustrating the light intensity reflected from an off-pattern object portion as a function of advancement along vector v(x,y).

Once processor 610 detects x-y plane edges 730-735 the computer processor then applies a curve fitting function based on the selected template with it corresponding constraints and the detected edges. This is shown in FIG. 9 on a graph in which points 724-727 are taken from the depth map and the value of point 730-728 have been extrapolated based on the existing data and the curve fitting function.

Finally, after all z-axis data has been estimated for edge points 731-735, the depth map may be completed based on the derived z-axis data of the edges.

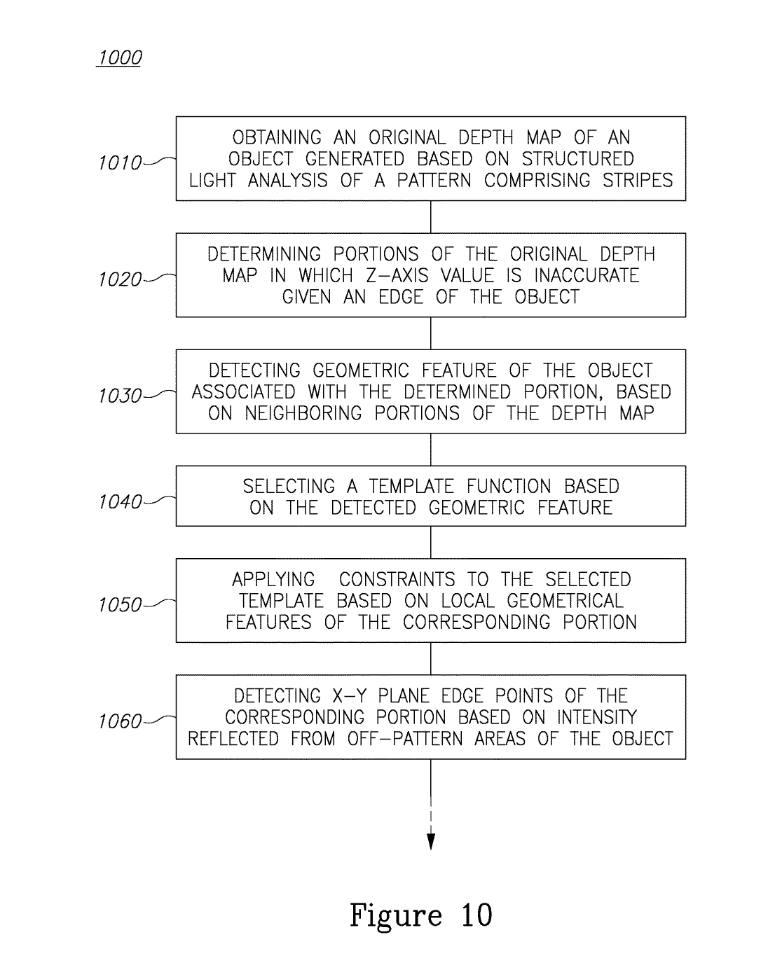

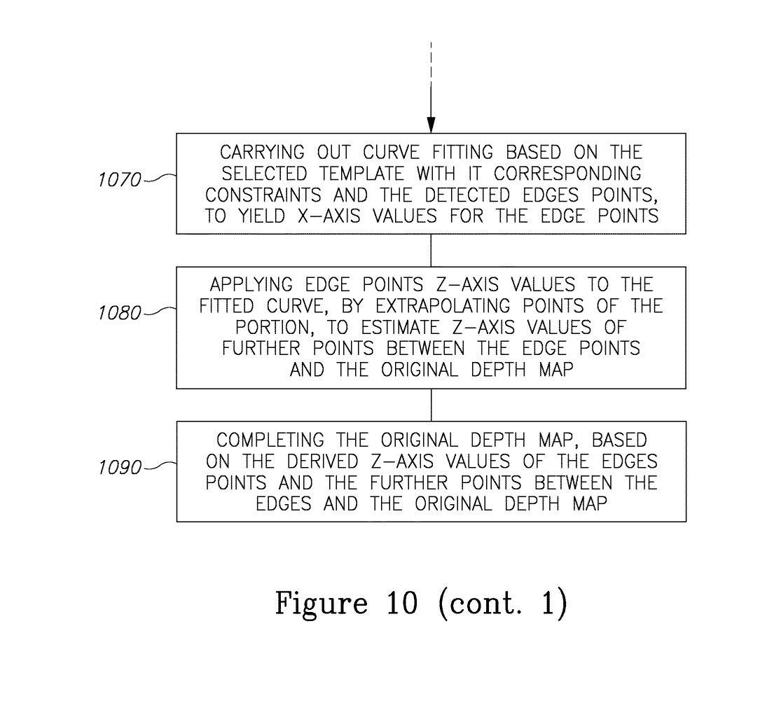

FIG. 10 is a flowchart that illustrates the steps of a non-limiting exemplary method 1000 in accordance with embodiments of the present invention. Method 1000 may include: obtaining an depth map of an object generated based on structured light analysis of a pattern comprising for examples stripes 1010 (other patterns can also be used); determining portions of the depth map in which z-axis value is inaccurate or in complete given an edge of the object 1020; detecting geometric feature of the object associated with the determined portion, based on the edges of the lines of the depth map 1030; selecting a template function based on the detected geometric feature 1040; applying constraints to the selected template based on local geometrical features of the corresponding portion 1050; detecting x-y plane edge points of the corresponding portion based on intensity reflected from off-pattern areas of the object 1060; carrying out curve fitting based on the selected template with it corresponding constraints and the detected edges points, to yield x-axis values for the edge points 1070; applying edge points z-axis values to the fitted curve, by extrapolating points of the portion, to estimate z-axis values of further points between the edge points and the original depth map 1080; and completing the original depth map, based on the derived z-axis values of the edges points and the further points between the edges and the original depth map 1090.

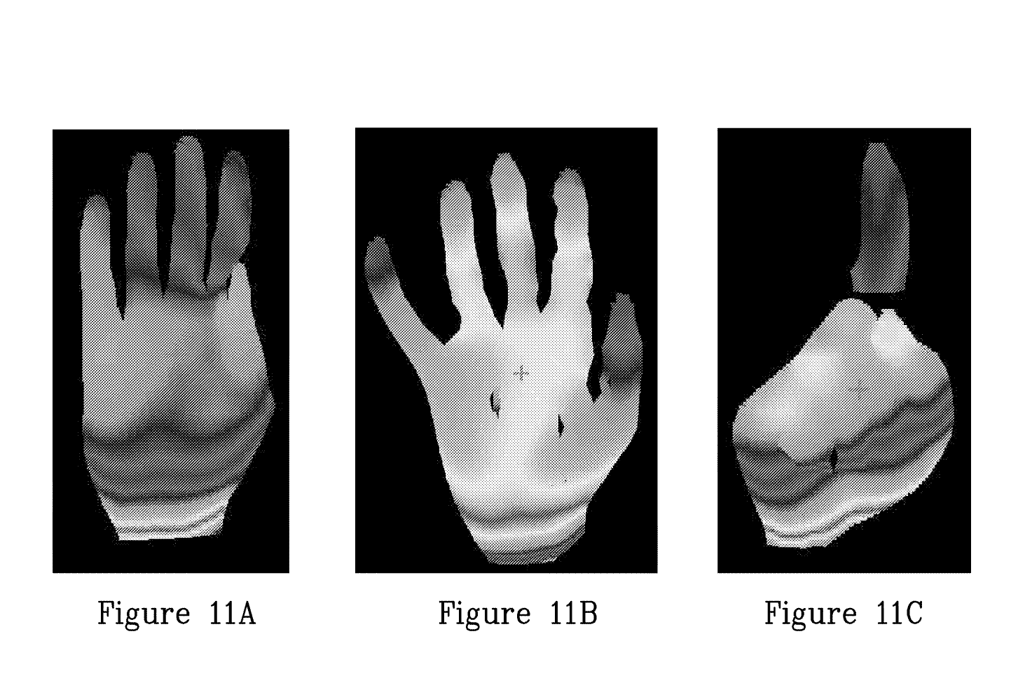

FIGS. 11A-11C are exemplary color depth maps illustrating aspects in accordance with embodiments of the present invention. Some of the undesirable effects discussed above such as cut off fingers and obscured thumb are shown herein.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A method comprising:
obtaining a depth map of an object generated based on structured light analysis of a pattern comprising stripes;
determining portions of the depth map in which z-axis value is inaccurate or in complete given an edge of the object;
detecting geometric feature of the object associated with the determined portion, based on edges of the depth map; and
estimating the z-axis data along the edge of the object, based on the detected geometric feature of the object.

2. The method according to claim 1, further comprising: selecting a template function based on the detected geometric feature; and applying constraints to the selected template based on local geometrical features of the corresponding depth map portion.

3. The method according to claim 2, further comprising detecting x-y plane edges of the corresponding portion based on intensity reflected from off-pattern areas.

4. The method according to claim 3, further comprising applying curve fitting function based on the selected template with it corresponding constraints and the detected edges.

5. The method according to claim 4, further comprising applying z-axis data to the fitted curve, based on extrapolation from the data map portion.

6. The method according to claim 5, further comprising completing the depth map based on the derived z-axis data of the edges.
